(19) United States
(12) Patent Application Publication
(10) Pub. No.: US 2019/0353321 A1
(43) Pub. Date: Nov. 21, 2019

(54) LIGHT GUIDE WITH MOLDED IN GRAPHIC

(71) Applicant: GM Global Technology Operations LLC, Detroit, MI (US)

(72) Inventors: Andrzej Wasilewski, Shelby Township, MI (US); Jeffrey T. Zawacki, Oxford, MI (US)

(21) Appl. No.: 15/979,962

(22) Filed: May 15, 2018

(51) Int. Cl. F21S 41/50; F21S 41/20; F21S 43/50; F21S 43/20

(52) U.S. Cl. CPC F21S 41/50; F21S 41/285; F21Y 2115/10; F21S 43/26; F21S 43/50

(57) ABSTRACT

A light assembly for a motor vehicle includes a first injection molded light diffusing layer, a graphic layer disposed on the first injection molded light diffusing layer, and a second injection molded layer disposed on the graphic layer. The graphic layer is covered by the second injection molded layer.

### INTRODUCTION

The present disclosure relates to light guides having molded graphics, including films or inks, used in motor vehicles.

Motor vehicles are increasingly employing lighting technology to improve the function and appearance of the motor vehicle. For example, headlamps, day lamps, running lights, rear lamps, side lamps, and rail lamps may be used to illuminate the vehicle and the vehicle surroundings while also being aesthetically pleasing. One type of lighting technology used with these lamps includes light guides. Light guides diffuse the light from light emitting sources to provide a soft glow for functional and/or aesthetic purposes. Graphics may be laser etched onto the light guide to provide additional aesthetic design options.

Thus, while current light guides achieve their intended purpose, there is a need for new and improved light guide designs that do not employ laser etching.

### SUMMARY

According to several aspects, a light assembly for a motor vehicle includes a first injection molded light diffusing layer, a graphic layer disposed on the first injection molded light diffusing layer, and a second injection molded layer disposed on the graphic layer. The graphic layer is covered by the second injection molded layer.

In one aspect, the graphic layer is a film.

In another aspect, the graphic layer is an ink deposited on the first injection molded light diffusing layer.

In another aspect, the second injection molded layer is a light diffusing layer.

In another aspect, the second injection molded layer is an outer lens of the motor vehicle.

In another aspect, the second injection molded layer is transparent.

In another aspect, the first injection molded light diffusing layer is comprised of a polymer embedded with a light diffuser.

In another aspect, the polymer is selected from the group consisting of polycarbonate, polymethyl methacrylate (PMMA), and silicone.

In another aspect, the light diffuser is titanium dioxide.

In another aspect, the second injection molded layer is a light diffusing layer, and further comprising an injection molded transparent outer lens disposed on a portion of the second injection molded layer.

In another aspect, the injection molded transparent outer lens is disposed on a portion of the first injection molded light diffusing layer.

According to several aspects, a light assembly for a motor vehicle includes a first injection molded light diffusing layer, a graphic layer disposed on the first injection molded light diffusing layer, and a second injection molded light diffusing layer disposed on the graphic layer. The graphic layer is covered by the second injection molded light diffusing layer.

In another aspect, a third injection molded layer is disposed on the second injection molded light diffusing layer.

In another aspect, the third injection molded layer is transparent.

In another aspect, the third injection molded layer is shaped as an outer lens of the motor vehicle and partially surrounds both the first injection molded light diffusing layer and the second injection molded light diffusing layer.

In another aspect, the graphic layer is a film.

In another aspect, the graphic layer is an ink deposited on the first injection molded light diffusing layer.

In another aspect, the graphic layer is completely surrounded by the first injection molded light diffusing layer and the second injection molded light diffusing layer.

In another aspect, a light source is adjacent the first injection molded light diffusing layer and the second injection molded light diffusing layer, the light source configured to emit light through the first injection molded light diffusing layer and the second injection molded light diffusing layer.

According to several aspects, a light assembly for a motor vehicle includes a first injection molded light diffusing layer, a graphic layer disposed on the first injection molded light diffusing layer, wherein the graphic layer consists of a film or an ink, a second injection molded light diffusing layer disposed on the graphic layer, and a third injection molded transparent layer disposed on the second injection molded light diffusing layer. The first injection molded light diffusing layer, the second injection molded light diffusing layer, and the third injection molded transparent layer are each configured to exhibit the properties of an injection molded material.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a side cross-section of a light assembly;

FIG. 2A is an exploded isometric cross-section of the light assembly of FIG. 1 in a first molding condition;

FIG. 2B is an exploded isometric cross-section of the light assembly of FIG. 1 in a second molding condition;

FIG. 2C is an exploded isometric cross-section of the light assembly of FIG. 1 in a third molding condition;

FIG. 3 is a side cross-section of another aspect of a light assembly; and

FIG. 4 is a side cross-section of yet another aspect of a light assembly.

### DETAILED DESCRIPTION

The following description is merely exemplary in nature and is not intended to limit the present disclosure, application, or uses.

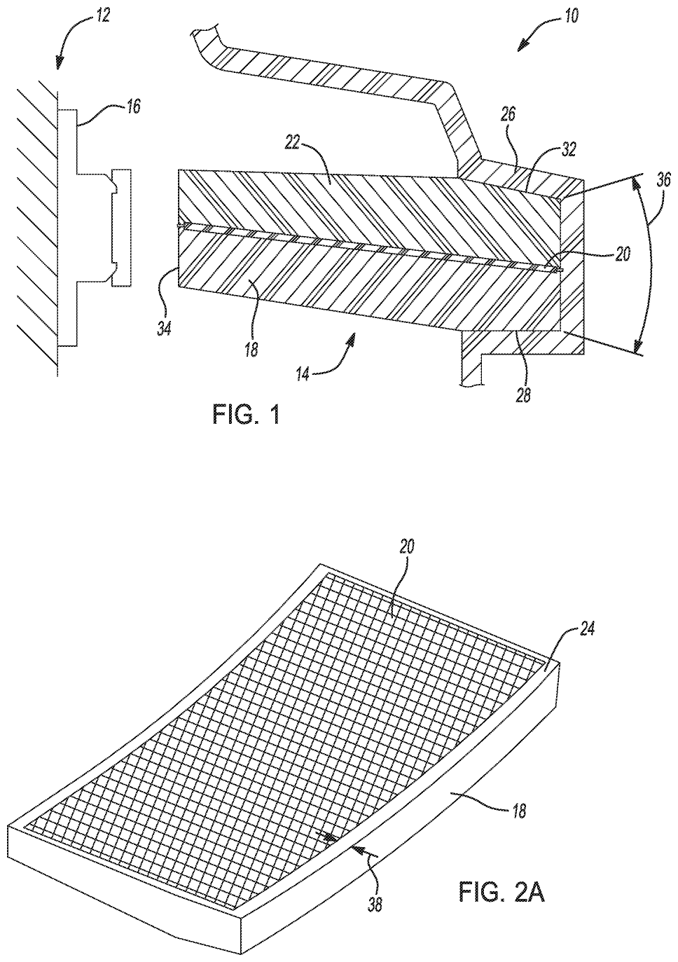

Referring to the Figures in general, wherein like reference numbers correspond to like or similar components throughout the several figures, and referring specifically to FIG. 1, a light assembly is generally indicated by reference number 10. The light assembly 10 is intended to be used with a motor vehicle (not shown). Examples of motor vehicles can include cars, trucks, motorcycles, boats, watercraft, all-terrain vehicles, drones, aircraft, farm equipment or any other suitable vehicle. The light assembly 10 may be used with forward facing headlamps, rearward facing rearlamps or brakelights, turn signals, fog lights, running lights, and/or rail lights. In addition, the light assembly 10 may be used in an interior of the motor vehicle with dome lights, accents lights, reading lights, etc. Thus, the shape and size of the light assembly 10 may vary from the examples shown in the figures and be specific to a given application. Generally, the light assembly 10 includes a light source 12 and a light guide 14. As will be described below, the light guide 14 includes a molded-in graphic that does not require laser etching.

The light source 12 is configured to selectively emit light into the light guide 14 and may take various forms. For example, the light source 12 may include a light emitting diode (LED) 16. It should be appreciated that the light source may include other types of light producing modules instead of the LED 16. In addition, the light source may include lamps, lenses, bezels, and other components without departing from the scope of the present disclosure.

The light guide 14 is configured to diffuse the light emitted from the light source 12. Throughout the examples provided below, the light guide 14 includes a first injection molded layer, a graphics layer disposed on the first layer, and a second injection molded layer disposed on the graphics layer. Each of the layers are configured to exhibit the properties of an injection molded material. The first injection molded layer is a light diffusing layer. In some examples the second injection molded layer is a light diffusing layer while in other examples the second injection molded layer is transparent. Also, in some examples a third layer is disposed over the second layer to form an outer lens while in other examples the second injection molded layer forms the outer lens of the light assembly. In each example, the graphic layer is molded in to the light guide 14 by the first and second layer.

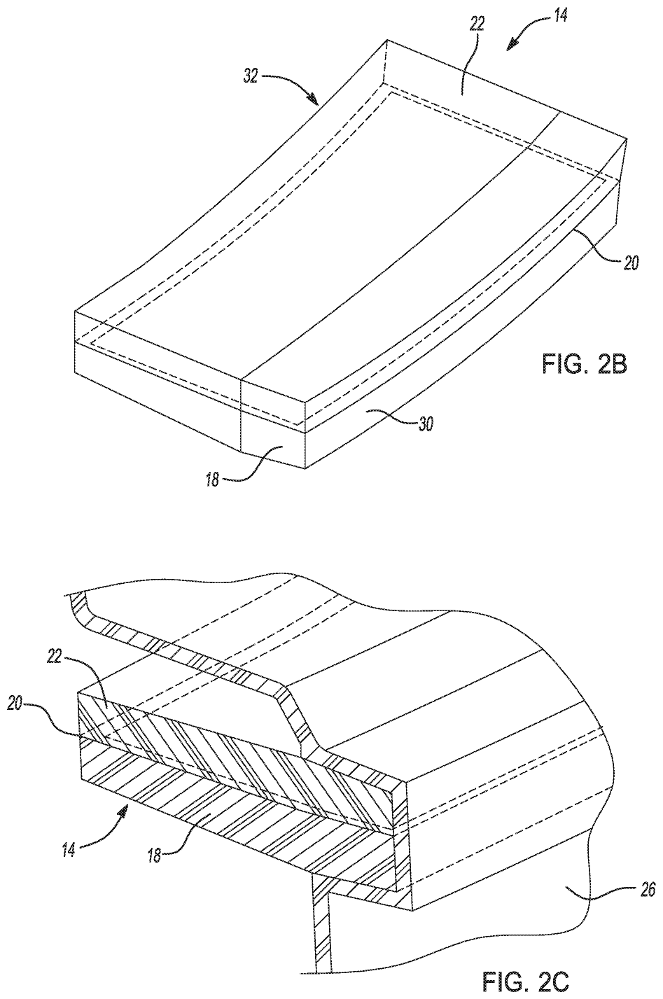

Referring to FIG. 1 and FIGS. 2A-2C, in one example the light guide 14 includes a first injection molded light diffusing layer 18, a graphic layer 20, and a second injection molded light diffusing layer 22. The first injection molded light diffusing layer 18 is configured to diffuse light emitted by the light source 12. In one example, the first injection molded light diffusing layer 18 is comprised of a polymer embedded with a light diffuser. The polymer is selected from the group consisting of polycarbonate, polymethyl methacrylate (PMMA), and silicone. However, it should be appreciated that other polymers may be used without departing from the scope of the present disclosure. The light diffuser is preferably titanium dioxide, though other light diffusers may be embedded within the polymer without departing from the scope of the present disclosure.

The graphic layer 20 is deposited onto a top surface 24 of the first injection molded light diffusing layer 18. The graphic layer 20 provides an aesthetic ornamentation to the light guide 14. In one example, the graphic layer 20 is a film having markings thereon. In another example, the graphic layer 20 is an ink deposited on the first injection molded light diffusing layer 18. The ink may either be deposited via a film or by direct application using a spray applicator, etc.

The second injection molded light diffusing layer 22 is molded overtop the graphic layer 20. In one example, the graphic layer 20 is completely covered and surrounded by the first and second injection molded light diffusing layers 18, 22. The second injection molded light diffusing layer 22 is configured to diffuse light emitted by the light source 12. In one example, the second injection molded light diffusing layer 22 is comprised of a polymer embedded with a light diffuser. The polymer is selected from the group consisting of polycarbonate, polymethyl methacrylate (PMMA), and silicone. However, it should be appreciated that other polymers may be used without departing from the scope of the present disclosure. The light diffuser is preferably titanium dioxide, though other light diffusers may be embedded within the polymer without departing from the scope of the present disclosure.

An outer lens 26 is injection molded to a portion of the light guide 14. Generally, the outer lens 26 can be manufactured from transparent material(s), such as but not limited to, a polycarbonate material. The outer lens 26 provides a front cover for the components of the light assembly 10, which prevents fluid and/or debris, etc. from entering the light assembly 19. The outer lens 26 is configured to allow the light to pass therethrough. In the example provided, the outer lens 26 wraps around a portion of a bottom surface 28 of the light guide 14, a first side surface 30 of the light guide 14, and a portion of a top surface 32 of the light guide 14. Thus, the graphic layer 20 is visible through the outer lens 26 when viewed from above. The light source 12 is positioned proximate a second side surface 34 of the light guide 14. Light emitted from the light source 12 travels through the light guide 14 and is diffused by the first and second injection molded light diffusing layers 18, 22. In one aspect, light is emitted through a “window” 36 in the first side surface 30 and outer lends 26. The area of the window 36 is defined by a daytime running light function that defines an acceptable window of uninterrupted light emission required or desired for motor vehicles. In this example, the graphic layer 20 is parallel, or edge on, to the light source 12 so as to minimize blocking of the window 36.

With reference to FIG. 2A, the light guide 14 is preferably manufactured by injection molding the first injection molded light diffusing layer 18 in a first shot or injection. Next, the graphic layer 20 is applied to the top surface 24 of the first injection molded light diffusing layer 18. In one aspect the graphic layer 20 is positioned such that a perimeter of the graphic layer 20 is offset by an amount 38 from a perimeter of the first injection molded light diffusing layer 18. The offset 38 may be constant or vary around the perimeters of the graphic layer 20 and the first injection molded light diffusing layer 18. The offset 38 assures that the graphic layer 20 is completely molded within the light guide 14. With reference to FIG. 2B, the second light diffusing layer 22 is molded onto the graphic layer 20 and the first injection molded light diffusing layer 18 in a second shot or injection. Due to the offset 38, the graphic layer 20 is completely surrounded. Finally, with reference to FIG. 2C, the outer lens 26 is injection molded onto the light guide 14 in a third shot or injection.

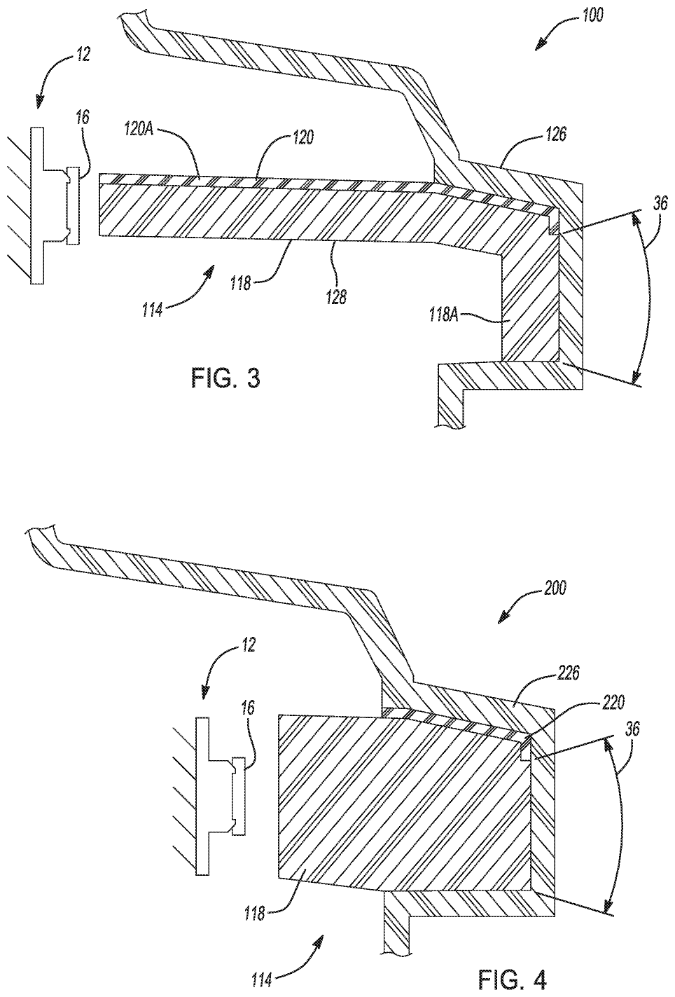

Turning now to FIG. 3, another example of a light assembly is generally indicated by reference number 100. The light assembly 100 is substantially similar to the light assembly 10 shown in FIGS. 1 and 2A-C and therefore like components are indicated by like reference numbers. However, in the light assembly 100, the light guide 14 is replaced with a light guide 114 having a first injection molded light diffusing layer 118, a graphic layer 120, and a second injection molded layer or outer lens 126 that partially covers the graphic layer 120. Thus, the light guide 114 does not include a light diffusing layer overtop the graphic layer 120. The first injection molded light diffusing layer 118 is similar to the first injection molded light diffusing layer 18 but includes a rim or arm 118A that extends from a bottom surface 128 of the first injection molded light diffusing layer 118. The graphic layer 120 is similar to the graphic layer 20 but has a shape that follows the contour of the first injection molded light diffusing layer 118. Unlike in the light guide 14, the graphic layer 120 includes a portion 120A not covered by the second injection molded layer 126. The second injection molded layer or outer lens 126 is similar to the outer lens 26.

Turning now to FIG. 4, another example of a light assembly is generally indicated by reference number 200. The light assembly 200 is substantially similar to the light assembly 100 shown in FIG. 3 and therefore like components are indicated by like reference numbers. However, in the light assembly 200, the light guide 114 is replaced with a light guide 214 having a first injection molded light diffusing layer 218, a graphic layer 220, and a second injection molded layer or outer lens 226 that completely covers the graphic layer 220. The first injection molded light diffusing layer 218 is similar to the first injection molded light diffusing layer 118 but does not include the rim or arm 118A. The graphic layer 220 is similar to the graphic layer 120 but does not include a portion not covered by molded material. The second injection molded layer or outer lens 226 is similar to the outer lens 126.

The light guides 14, 114, and 214 provide additional light design options without requiring laser etching. Thus, manufacturing process time is reduced and enhanced accents to the light assembly 10 are possible beyond those provided in laser etching techniques.

The terms “top”, “overtop”, “bottom”, “side” and “above” are terms used relative to the orientation of the light assembly 10 as shown in the drawings of the present application. Thus, while the orientation of the light assembly 10 may change with respect to a given use, these terms are intended to still apply relative to the orientation of the components of the light assembly 10 as shown in the drawings.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A light assembly for a motor vehicle comprising:
a first injection molded light diffusing layer having a polymer embedded with a light diffuser;
a graphic layer disposed on the first injection molded light diffusing layer; and
a second injection molded layer disposed on the graphic layer, wherein the graphic layer is covered by the second injection molded layer, and the second injection molded layer is a light diffusing layer having a polymer embedded with a light diffuser.

2. The light assembly of claim 1 wherein the graphic layer is a film.

3. The light assembly of claim 1 wherein the graphic layer is an ink deposited on the first injection molded light diffusing layer.

4.-7. (canceled)

8. The light assembly of claim 1 wherein the polymer is selected from the group consisting of polycarbonate, polymethyl methacrylate (PMMA), and silicone.

9. The light assembly of claim 8 wherein the light diffuser is titanium dioxide.

10. The light assembly of claim 1 further comprising an injection molded transparent outer lens disposed on a portion of the second injection molded layer.

11. The light assembly of claim 10 wherein the injection molded transparent outer lens is disposed on a portion of the first injection molded light diffusing layer.

12. A light assembly for a motor vehicle comprising:
a first injection molded light diffusing layer having a polymer embedded with a light diffuser;
a graphic layer disposed on the first injection molded light diffusing layer; and
a second injection molded light diffusing layer disposed on the graphic layer, wherein the graphic layer is covered by the second injection molded light diffusing layer and the second injection molded light diffusing layer having a polymer embedded with a light diffuser; and
a third injection molded layer disposed on the second injection molded light diffusing layer,
wherein the graphic layer is completely surrounded by the first injection molded light diffusing layer and the second injection molded light diffusing layer and a perimeter of the graphic layer is offset by an amount from a perimeter of the first injection molded light diffusing layer.

13. (canceled)

14. The light assembly of claim 12 wherein the third injection molded layer is transparent.

15. The light assembly of claim 14 wherein the third injection molded layer is shaped as an outer lens of the motor vehicle and partially surrounds both the first injection molded light diffusing layer and the second injection molded light diffusing layer.

16. The light assembly of claim 12 wherein the graphic layer is a film.

17. The light assembly of claim 12 wherein the graphic layer is an ink deposited on the first injection molded light diffusing layer.

18. (canceled)

19. A light assembly for a motor vehicle comprising:
a first injection molded light diffusing layer having a polymer embedded with a light diffuser;
a graphic layer disposed on the first injection molded light diffusing layer, and
a second injection molded light diffusing layer disposed on the graphic layer, wherein the graphic layer is covered by the second injection molded light diffusing layer and the second injection molded light diffusing layer having a polymer embedded with a light diffuser;
a third injection molded layer disposed on the second injection molded light diffusing layer, and
a light source adjacent the first injection molded light diffusing layer and the second injection molded light diffusing layer, the light source configured to emit light through the first injection molded light diffusing layer and the second injection molded light diffusing layer edge on to the graphic layer.

20. (canceled)
